(19) United States
(12) Patent Application Publication
(10) Pub. No.: US 2016/0375461 A1
(43) Pub. Date: Dec. 29, 2016

(54) AUTOMATED COATING APPLICATION

(71) Applicant: Rolls-Royce Corporation, Indianapolis, IN (US)

(72) Inventor: Duncan Philip Taylor, Indianapolis, IN (US)

(21) Appl. No.: 15/184,235

(22) Filed: Jun. 16, 2016

Related U.S. Application Data
(60) Provisional application No. 62/184,090, filed on Jun. 24, 2015.

(51) Int. Cl. B05C 17/035

(52) U.S. Cl. CPC B05C 17/035

(57) ABSTRACT

An example system includes a transfer roller including a roller surface, a cliché configured to present a layer of coating material to the roller surface, a roller manipulator configured to move the transfer roller relative to the cliché and an object including a plurality of raised features, and a computing device. An example computing device includes a manipulator control module configured to control the roller manipulator to move the transfer roller to contact the cliché with a first predetermined force, move the transfer roller relative to the cliché to receive coating material while substantially maintaining the first predetermined force, move the transfer roller to contact the object with a second predetermined force, and move the transfer roller relative to the object while substantially maintaining the second predetermined force to coat each raised feature of the plurality of raised features with a predetermined thickness of the coating material.

This application claims the benefit of U.S. Provisional Application No. 62/184,090, filed Jun. 24, 2015 and titled, “AUTOMATED COATING APPLICATION,” the entire content of which is incorporated herein by reference.

### TECHNICAL FIELD

The disclosure relates to automated coating application.

### BACKGROUND

Coatings are extensively used in a wide variety of industrial applications to coat various surfaces. Certain surface geometries, including curvatures, may make providing a coating having a desired pattern and thickness difficult and slow.

### SUMMARY

In some examples, a system includes a transfer roller including a roller surface, a cliché configured to present a layer of coating material to the roller surface, a roller manipulator configured to move the transfer roller relative to the cliché and an object including a plurality of raised features, and a computing device. The computing device may include a manipulator control module configured to control the roller manipulator to move the transfer roller to contact the cliché with a first predetermined force, move the transfer roller relative to the cliché to receive coating material from the layer of coating material while substantially maintaining the first predetermined force between the transfer roller and the cliché, move the transfer roller to contact the object with a second predetermined force, and move the transfer roller relative to the object while substantially maintaining the second predetermined force between the transfer roller and the object to coat each raised feature of the plurality of raised features in a predetermined surface region of the object with a predetermined thickness of the coating material.

In some examples, a technique includes controlling, by a computing device, a first motion of a transfer roller to contact a cliché with a first predetermined force. The technique may further include controlling, by the computing device, a second motion of the transfer roller across the cliché to receive on a roller surface of the transfer roller a layer of coating material presented on the cliché while maintaining the first predetermined force between the roller surface and the cliché. In some examples, the technique also includes controlling, by the computing device, a third motion of the transfer roller to contact an object comprising a plurality of raised features with a second predetermined force. The example technique additionally may include controlling, by the computing device, a fourth motion of the transfer roller relative to the object while substantially maintaining the second predetermined force between the transfer roller and the object to coat each raised feature of the plurality of raised features in a predetermined surface region of the object with a predetermined thickness of the coating material.

In some examples, a computer readable storage medium includes instructions that, when executed, cause at least one processor to control a first motion of a transfer roller to contact a cliché with a first predetermined force. The computer readable storage medium may additionally include instructions that, when executed, cause the at least one processor to control a second motion of the transfer roller across the cliché to receive on a roller surface of the transfer roller a layer of coating material presented on the cliché while maintaining the first predetermined force between the roller surface and the cliché. In some examples, the computer readable storage medium further includes instructions that, when executed, cause the at least one processor to control a third motion of the transfer roller to contact an object comprising a plurality of raised features with a second predetermined force. In some examples, the computer readable storage medium also includes instructions that, when executed, cause the at least one processor to control a fourth motion of the transfer roller relative to the object while substantially maintaining the second predetermined force between the transfer roller and the object to coat each raised feature of the plurality of raised features in a predetermined surface region of the object with a predetermined thickness of the coating material.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual and schematic block diagram illustrating an example system for coating a plurality of raised features of an object with coating material.

FIG. 1B is a conceptual and schematic diagram illustrating a top-down view from line A-A of FIG. 1A.

FIG. 1C is a conceptual and schematic diagram illustrating a magnified region B of FIG. 1A.

FIG. 2 is a conceptual block diagram illustrating an example computing device including at least one processor that contains instructions causing a system to coat a plurality of raised features of a body with coating material.

FIG. 3 is a flow diagram illustrating an example technique for coating a plurality of raised features of a body with coating material.

### DETAILED DESCRIPTION

The disclosure describes systems and techniques for coating a coating material on substantially only (e.g., only or nearly only) a plurality of raised features of an object. A system may include a transfer roller, a cliché, and a computing device. The computing device may control a first motion of the transfer roller to contact the cliché with a first predetermined force, and may control a second motion of the transfer roller across the cliché while substantially maintaining (e.g., maintaining or nearly maintaining) the first predetermined force. For example, the computing device may control the transfer roller to roll across the cliché to receive a coating material from a layer of coating material presented by the cliché. The computing device may control a third motion of the transfer roller to contact the object including the plurality of raised features with a second predetermined force, and may control a fourth motion of the transfer roller relative to the object while substantially maintaining (e.g., maintaining or nearly maintaining) the second predetermined force. For example, the computing device may control the transfer roller to roll across a predetermined surface region of the object to coat each raised feature of the plurality of raised features in the predetermined surface region with a predetermined thickness of the coating material. In some examples, the coating material includes a binder for temporarily or permanently bonding metal or alloy surfaces. In this way, by controlling the roller to move relative to the object while substantially maintaining the second predetermined force, the systems and techniques described herein may deposit a substantially uniform (e.g., uniform or nearly uniform) coating and substantially only (e.g., only or nearly only) surfaces of the plurality of raised features, even in instances in which a surface of the object in the predetermined surface region is curved.

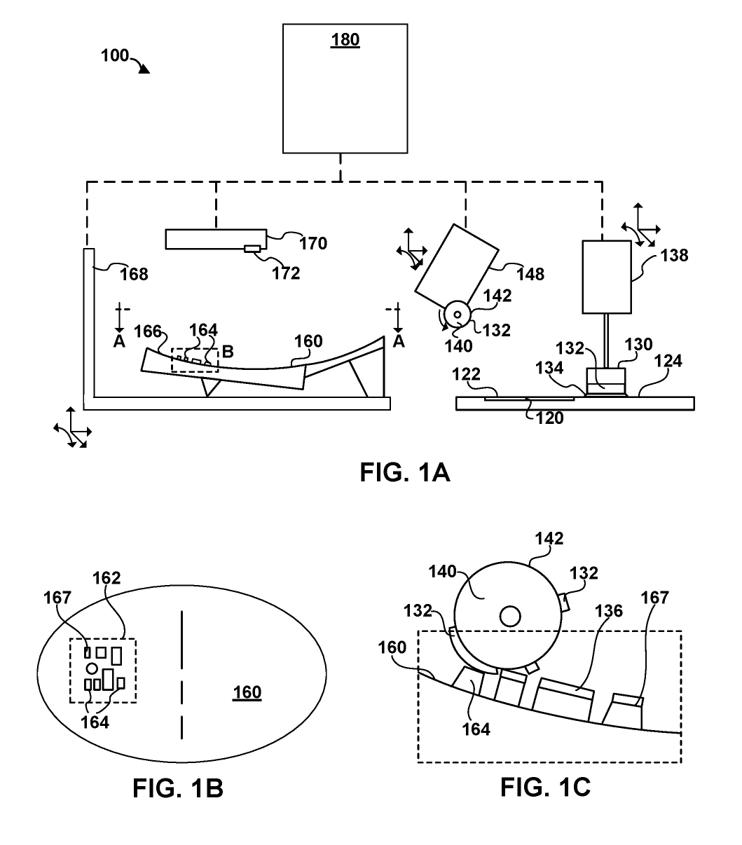

FIG. 1A is a conceptual and schematic block diagram illustrating an example system 100 for coating a plurality of raised features 164 of an object 160 with coating material. FIG. 1B is a conceptual diagram illustrating a top-down view from line A-A of FIG. 1A. FIG. 1C is a conceptual diagram illustrating a magnified region B of FIG. 1A. As shown in FIG. 1A, system 100 may include a transfer roller 140 for transferring a coating material 132 to an object 160 and a cliché 120 for presenting coating to transfer roller 140. In some examples, system 100 includes at least one of a doctoring cup 130 for supplying cliché 120 with coating material 132, a vision system 170 for inspecting a coating material layer 136 on object 160, or a computing device 180 for controlling at least one of transfer roller 140, doctoring cup 130, vision system 170, or object 160.

In some examples, object 160 may include metal or alloy. For example, object 160 may include a Ni-, Co-, Fe-, or Ti-based alloy or superalloy. In some examples, object 160 may be a molded, forged, or casted component, such as, a component of a high temperature mechanical system. In some examples, object 160 may include a predetermined surface region 162 on a surface 166 of object 160, as seen in FIG. 1B. Predetermined surface region 162 may include any surface geometry, including at least one of flat, curved, undulating, or irregular.

Predetermined surface region 162 includes a plurality of raised features 164. Each raised feature of plurality of raised features 164 has a feature surface 167. In some examples, each raised feature of plurality of raised features 164 may define a substantially similar shape. In other examples, at least one raised feature of plurality of raised features 164 may define a different shape than at least one other raised feature of plurality of raised features 164. The shape of plurality of raised features 164 may refer to the shape, or geometry, of plurality of raised features 164 in any dimension or cross-sectional plane. FIGS. 41A to 1C illustrate an example in which each raised feature of plurality of raised features 164 has substantially the same height relative to surface 166, but, in a plane substantially parallel to surface 166, some raised features of plurality of raised features 164 define a different geometry (e.g., shape, size, or both) than some other raised features of plurality of raised features 164. In other examples, one or more raised features of plurality of raised features 164 may have different heights relative to surface 166 in a direction measured substantially normal to surface 166. In some examples, each raised feature of plurality of raised features 164 may have a height between about 20 thousands of an inch (about 0.5 mm) and about 40 thousandths of an inch (about 1 mm). In some examples, each raised feature of plurality of raised features 164 may have an upper surface area (e.g., a surface area of features surfaces 167) of about 40 thousandths of an inch square (about 1 mm square).

In some examples, each raised feature of plurality of raised features 164 is an attachment point to attach object 160 to another component. For example, plurality of raised features 164 may include pedestals or pillars to which another metal or alloy component is to be attached. In some examples, object 160 may be attached to another component by, for example, at least one of adhesive bonding, diffusion bonding, welding, or brazing plurality of raised features 164 to the other component.

Coating material 132 may include at least one transferable medium or composition that may be transferred from one surface to another. In some examples, coating material 132 may include a binder that may temporarily or permanently bond metal or alloy surfaces and may be applied to feature surfaces 167 of plurality of raised features 164. Thus, in some examples, coating material 132 may be used to temporarily bond object 160 to another component for further processing, or may be used to permanently bond object 160 to another component for fabricating a structure.

In some examples, coating material 132 may include additives such as pigments or fluorescing agents that modify the visibility or appearance of surfaces coated with coating material 132, or for allowing object 160 to be inspected after coating features surfaces 167 with coating material 132 to verify the application of coating material 132 to desired portions of object 160.

In some examples, coating material 132 may be applied substantially only to a respective feature surface 167 of each raised feature of plurality of raised features 164. For example, after applying coating material 132 including binder to plurality of raised features 164, the other component may be brought in contact with plurality of raised features 164 of object 160, so that coating material 132 temporarily or permanently bonds object 160 to the other component.

Cliché 120 may present coating material 132 so that transfer roller 140 may receive coating material 132 from cliché 120 before applying coating material 132 to plurality of raised features 164. Cliché 120 includes a contact surface 122 for presenting coating material 132 as a layer of substantially uniform (e.g., uniform or nearly uniform) thickness. In some examples, cliché 120 includes a printing plate, for example, an engraved or etched printing plate. In some examples, contact surface 122 may include a metal surface, or a polymer surface on a metal backing, the metal or polymer surface engraved or etched with a predetermined pattern, for example, by UV or other etching techniques. In some examples, the etched pattern may include a plurality of grooves that assists in retaining a layer of coating material 132 with a substantially uniform (uniform or nearly uniform) thickness across contact surface 122, or in transferring a uniform layer of coating material 132 to a roller surface 142 of transfer roller 140, or both, at least by retaining a predetermined amount of coating material 132 within each groove. In some examples, the number of grooves per unit area of contact surface 122 may be determined based on the density and viscosity of coating material 132. For example, the number of grooves per unit area may be inversely proportional to one or both of density or viscosity of coating material 132. In some examples, contact surface 122 may include stripes of coating material with stripe thickness and spacing corresponding to size and spacing of raised features of plurality of raised features 164. While in some examples, cliché 120 includes a plate, as illustrated in FIG. 1A, in other examples, cliché 120 may include a roller, cylinder, or any other cliché geometry that can be used to present a layer of coating material 132 with a substantially uniform (e.g., uniform or nearly uniform) thickness to transfer roller 140. Thus, in some examples, transfer roller 140 may receive from contact surface 122 of cliché 120 a layer of coating material 132 with a substantially uniform (e.g., uniform or nearly uniform) thickness on roller surface 142.

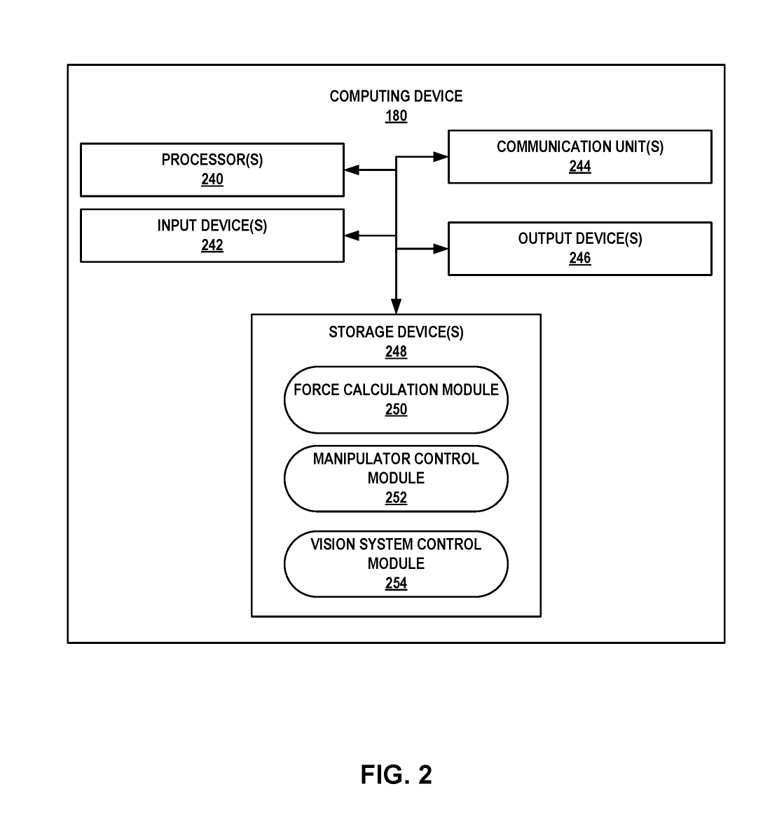

In some examples, system 100 includes computing device 180 for controlling at least one of a roller manipulator 148, an object manipulator 168, a cup manipulator 138, or vision system 170. For example, computing device 180 may include a manipulator control module for controlling one or more of roller manipulator 148, object manipulator 168, and cup manipulator 138, and a vision system control module for controlling vision system 170. In some examples, computing device 180 may include, for example, a desktop computer, a laptop computer, a workstation, a server, a mainframe, a cloud computing system, or the like. Computing device may communicate with components of system 100 via one or more networks, such as one or more wired or wireless networks. Computing device 180 is described below in examples with reference to FIG. 2.

In some examples, system 100 includes cup manipulator 138 for moving doctoring cup 130 relative to cliché 120 and an adjacent surface 124. In some examples, computing device 180 may control cup manipulator 138 to translate doctoring cup 130 along at least one selected direction, or rotate doctoring cup 138 about at least one axis, or both. In some examples, cup manipulator 138 includes a 6 axis robot.

Doctoring cup 130 contains a volume of coating material 132. In some examples, doctoring cup 130 is inverted so that the volume of coating material 132 is shielded from the environment by the body of doctoring cup 130, and so that the volume of coating material 132 is substantially only (e.g., only or nearly only) exposed to cliché 120 or adjacent surface 124. Such shielding may prevent premature drying or curing of the volume of coating material 132. In some examples, doctoring cup 130 includes doctoring edge 134, which maintains a substantially sealed (e.g., sealed or nearly sealed) sliding relationship with contact surface 122 of cliché 120 or adjacent surface 124 as cup manipulator 138 moves doctoring cup 130 between cliché 120 and adjacent surface 124 to control release of coating material 132 from doctoring cup 130 to contact surface 122 on cliché 120. Doctoring edge 134 also provides a layer of coating material 132 having a substantially uniform (e.g., uniform or substantially uniform) thickness on contact surface 122 of cliché 120. Thus, with each pass of doctoring cup 130 over cliché 120, contact surface 122 on cliché 120 is re-supplied with coating material 132 from doctoring cup 130. In some examples, doctoring cup 130 is replenished with coating material 132 from time to time.

In some examples, computing device 180 may control cup manipulator 138 to occasionally (e.g., periodically) reciprocate doctoring cup 130 between contact surface 122 and adjacent surface 124. In some examples, computing device 180 may control cup manipulator 138 and roller manipulator 148 to co-ordinate the reciprocation of doctoring cup 130 across contact surface 122 with each contact of transfer roller 140 with object 160, so that computing device 180 causes cup manipulator 138 to move doctoring cup 130 to resupply contact surface 122 with coating material 132 while computing device 180 causes roller manipulator 148 to move transfer roller 140 to coat plurality of raised features 164 with coating material layer 136. For example, transfer roller 140 may be sized based on curvature of object 160 within predetermined surface region 162, to allow coating curved regions in a direction along a rotational axis of transfer roller 140.

In some examples, system 100 may not include computing device 180, or manipulator control module 252, and motion of doctoring cup 130 may be controlled by mechanical mechanisms, for example, by guiding the movement of doctoring cup 130 along fixed cam tracks, slots, grooves, or other mechanically defined paths, and by mechanically imparting a predetermined fixed or variable velocity and force to doctoring cup 130, for example, using weights and springs. Alternatively, system 100 may include computing device 180, manipulator control module 252, or both, and computing device 180 or manipulator control module 252 may control motion of doctoring cup 130 in combination with at least one mechanical mechanism. For example, computing device 180, manipulator control module 252, or both may control a linear motion of doctoring cup 130, while a mechanical mechanism may control the force or spacing between doctoring cup 130 and contact surface 122.

In some examples, system 100 includes an object manipulator 168 for holding and moving object 160 relative to transfer roller 140. In some examples, computing device 180 may control object manipulator 168 to translate object 160 along at least one selected direction, or rotate object 160 about at least one selected axis. For example, object manipulator 168 may include a 6 axis robot. In some examples, computing device 180 may control object manipulator 168 to impart a selected linear speed to object 160 relative to transfer roller 140. In some examples, computing device 180 may control object manipulator 168 to reposition object 160 between or during multiple passes of transfer roller 140 relative to object 160 so that a selected region of object 160 is coated. In some examples, computing device 180 may control each pass of transfer roller 140 to overlap to a predetermined extent with a previous pass of transfer roller 140. In other examples, computing device 180 may control each pass of transfer roller 140 to substantially avoid overlapping with previous passes of transfer roller 140.

In some examples, system 100 includes roller manipulator 148 for controlling a motion of transfer roller 140 relative to cliché 120 and object 160, as seen in FIG. 1A. In some examples, computing device 180 may control roller manipulator 148 to translate transfer roller 140 along at least one selected direction, or rotate transfer roller 140 about at least one selected axis. In some examples, roller manipulator 148 may impart one or both of a desired linear speed, a desired rotational speed, or a desired circumferential speed to transfer roller 140. In some examples, roller manipulator 148 includes a rack and pinion gear train for translating transfer roller 140 along a line. In some examples, roller manipulator 148 includes linear bearings riding on vertical shaft to raise or lower transfer roller 140. In some examples, roller manipulator 148 includes a robotic manipulator capable of controlling motion of transfer roller 140 along at least one selected axis. For example, roller manipulator 148 may include a 6 axis robot. In some examples, roller manipulator 148 includes a servo motor for rotating transfer roller 140. In some examples, roller manipulator 148 may include springs or weighted mechanisms or other mechanical components capable of applying a predetermined fixed or variable force to roller 140 so that roller manipulator 148 can cause roller 140 to contact a selected surface with the predetermined force. Manipulator control module 252 may control a linear speed of transfer roller 140 relative to object 160 to be substantially equal to a circumferential speed (also known as peripheral speed) of roller surface 142, by controlling one or both of roller manipulator 148 and object manipulator 168. For example, such control may prevent slippage between roller surface 142 and object 160, and may promote substantially uniform (e.g., uniform or nearly uniform) application of coating material 132 to plurality of raised features 164 on object 160.

In some examples, system 100 may not include computing device 180, or manipulator control module 252, and transfer roller 140 may be controlled by mechanical mechanisms, for example, by guiding the movement of transfer roller 140 along fixed cam tracks, slots, grooves, or other mechanically defined paths, and by mechanically imparting a predetermined fixed or variable velocity and force to transfer roller 140, for example, using weights and springs. Alternatively, system 100 may include computing device 180, manipulator control module 252, or both, and computing device 180 or manipulator control module 252 may control motion of transfer roller 140 in combination with at least one mechanical mechanism. For example, computing device 180, manipulator control module 252, or both may control a linear motion of transfer roller 140, while a mechanical mechanism may control the force or rotational motion of transfer roller 140.

Transfer roller 140 includes a roller surface 142, which may receive a layer of coating material layer 132 from cliché 120 and transfer it to object 160 as shown in FIGS. 1A and 1C. In some examples, transfer roller 140 includes a rubber material (e.g., silicone rubber) that contacts cliché 120 to receive a layer of coating material layer 132 when computing device 180 controls roller manipulator 148 to cause transfer roller 140 to contact surface 122 of cliché 120 with a first predetermined force. The diameter and width of transfer roller 140 and thickness of roller surface 142 may be selected to provide predetermined coating characteristics. In some examples, transfer roller 140 may have a diameter of about 2 inches (about 50 mm) and a width of about 1 inch (about 25 mm), and roller surface 142 may have a thickness of about 0.75 inch (about 20 mm).

In some examples, as computing device 180 controls roller manipulator 148 to cause transfer roller 140 to move across contact surface 122 while substantially maintaining (e.g., maintaining or nearly maintaining) the first predetermined force, roller surface 142 of transfer roller 140 collects a layer of coating material 132 and depletes coating material 132 on contact surface 122 of cliché 120. In some examples, roller surface 142 retains coating material 136 as computing device 180 controls roller manipulator 148 to move from cliché 120 towards object 160, as shown in FIG. 1A. After transfer roller 140 receives a layer of coating material 132, computing device 180 may control roller manipulator 148 to cause transfer roller 140 to contact object 160 with a second predetermined force. In some examples, as computing device 180 controls roller manipulator 148 to cause transfer roller 140 to contact plurality of raised features 164 in predetermined surface region 162 while maintaining the second predetermined force, as shown in FIG. 1C. In some examples, computing device 180 may cause transfer roller 140 to repeatedly contact and move across different portions of surface region 162 in a predetermined number of passes, so that after completing the predetermined passes, computing device 180 causes transfer roller 140 to coat each raised feature of plurality of raised features 164 (e.g., feature surfaces 167) in surface region 162 with the second selected thickness of coating material layer 136. In some examples, coating material layer 136 may have a thickness in the order of thousandths of an inch (order of hundredths of an mm).

In some examples, in combination with controlling roller manipulator 148 to move transfer roller 140, computing device 180 may control object manipulator 168 to translate object 160 along at least one selected axis or rotate object 160 about at least one selected axis to position object 160 relative to transfer roller 140 and facilitate coating selected portions of object 160 with coating material 132. For example, computing device 180 may control object manipulator 168 to translate object 160 along at least one selected axis or rotate object 160 about at least one selected axis to facilitate access to surface regions of object 160 by transfer roller 140. For example, object manipulator 168 may provide object 160 with at least one degree of freedom of movement that is different from a degree of freedom of movement provided by roller manipulator 148 to transfer roller 140.

In some examples, system 100 may not include computing device 180, or manipulator control module 252, and object 160 may be controlled by mechanical mechanisms, for example, by guiding the movement of object 160 along fixed cam tracks, slots, grooves, or other mechanically defined paths, and by mechanically imparting a predetermined fixed or variable velocity and force to object 160, for example, using weights and springs. Alternatively, system 100 may include computing device 180, manipulator control module 252, or both, and computing device 180 or manipulator control module 252 may control motion of object 160 in combination with at least one mechanical mechanism.

Thus, in some examples, computing device 180 may control one or more of roller manipulator 148, object manipulator 168, and cup manipulator 138 to provide a coating of a selected thickness of coating material 132 on a respective feature surface 167 of each raised feature of plurality of raised features 164 in predetermined surface region 162 of object 160. System 100 may be used for automated application of coating material to substantially only the respective feature surface 167 of each raised feature of plurality of raised features 164, without operator or other human intervention, even if predetermined surface region 162 includes a curved surface of object 160, including compound curved surfaces.

In some examples, predetermined surface region 162 may include the entire external surface of object 160, and system 100 may coat substantially only the respective feature surface 167 of each raised feature of plurality of raised features 164 across the entire surface of object 160, while leaving unraised surface regions of object 160 between each raised feature of plurality of raised features 164 substantially uncoated (e.g., uncoated or nearly uncoated). In some examples, computing device 180 controls roller manipulator 148 to maintain transfer roller 140 substantially tangential (e.g., tangential or nearly tangential) to any curvature of predetermined surface region 162 while contacting object 160. This may allow application of coating material, for instance, binder, substantially only (e.g., only or nearly only) to plurality of raised features 164 so that object 160 may be bonded with another component substantially only (e.g., only or nearly only) at the respective feature surface 167 of each raised feature of plurality of raised features 164.

In some examples, system 100 includes vision system 170 for visually inspecting object 160 before, during, or after coating, so that a coating characteristic may be evaluated. In some examples, vision system 170 includes a camera 172. In some examples, coating material 132 may exhibit an optical characteristic (for example, at least one of color, saturation, visible intensity, infrared intensity, or ultraviolet intensity), and camera 172 may include one or more of color, monochrome, visible light, infrared, or ultraviolet sensors to detect where on object 160 coating material 132 is applied. Vision system 170 or computing device 180 may determine where on object 160 coating material 132 is applied by comparing images acquired before, during, or after coating. In some examples, vision system 170 or computing device 180 may determine a coating characteristic such as area of coating, a number of coated raised features of plurality of raised features 164, an average thickness of coating material layer 136 on plurality of raised features 164, or the like.

FIG. 2 is a conceptual block diagram illustrating computing device 180 of FIG. 1. As shown in FIG. 2, computing device 180 may include at least one processor 240 that executes instructions causing system 100 to coat a plurality of raised features 164 of object 160 with coating material 132. In some examples, computing device 180 may include, for example, a desktop computer, a laptop computer, a workstation, a server, a mainframe, a cloud computing system, programmable logic controller (PLC) or the like. In some examples, computing device 180 controls the operation of system 100, including, for example, at least one of roller manipulator 148, object manipulator 168, cup manipulator 138, or vision system 170.

In the example illustrated in FIG. 2, computing device 180 includes at least one processor 240, at least one input device 242, at least one communication unit 244, at least one output device 246, and at least one storage device 248. Computing device 180 also includes at least one of force calculation module 250, manipulator control module 252, or vision system control module 254. In other examples, computing device 180 may include additional components or fewer components than those illustrated in FIG. 2.

At least one processor 240 is configured to implement functionality and/or process instructions for execution within computing device 180. For example, at least one processor 240 may be capable of processing instructions stored by storage device 248. Examples of at least one processor 240 may include, any one or more of a microprocessor, a controller, a digital signal processor (DSP), an application specific integrated circuit (ASIC), a field-programmable gate array (FPGA), or equivalent discrete or integrated logic circuitry.

At least one storage device 248 may be configured to store information. At least one storage device 248, in some examples, may include a computer-readable storage medium or computer-readable storage device. In some examples, at least one storage device 248 may include a temporary memory, meaning that a primary purpose of at least one storage device 248 is not long-term storage. At least one storage device 248, in some examples, may include a volatile memory, meaning that at least one storage device 248 does not maintain stored contents when power is not provided to at least one storage device 248. Examples of volatile memories include random access memories (RAM), dynamic random access memories (DRAM), static random access memories (SRAM), and other forms of volatile memories known in the art. In some examples, at least one storage device 248 is used to store program instructions for execution by processors 240. At least one storage device 248, in some examples, may be used by software or applications running on computing device 180 to temporarily store information during program execution.

In some examples, at least one storage device 248 may further include one or more storage devices configured for longer-term storage of information. In some examples, at least one storage devices 248 may include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 180 may further include at least one communication unit 244. Computing device 180 may utilize at least one communication unit 244 to communicate with external devices (e.g., roller manipulator 148, object manipulator 168, cup manipulator 138, or vision system 170) via one or more networks, such as one or more wired or wireless networks. At least one communication unit 244 may include a network interface card, such as an Ethernet card, an optical transceiver, a radio frequency transceiver, or any other type of device that can send and receive information. In some examples, the communication connections may include network links, such as Ethernet, ATM, or other network connections. Such connections may be wireless and/or wired connections. In other examples, the communication connections may include other types of device connections, such as USB, IEEE 1394, or the like. Other examples of such network interfaces may include WiFi radios or Universal Serial Bus (USB). In some examples, computing device 180 utilizes at least one communication unit 244 to wirelessly communicate with an external device such as a server.

Computing device 180 also includes at least one input device 242. At least one input device 242, in some examples, may be configured to receive input from a user through tactile, audio, or video sources. Examples of at least one input device 242 include a mouse, a keyboard, a voice responsive system, video camera, microphone, touchscreen, or any other type of device for detecting a command from a user.

Computing device 180 may further include at least one output device 246. At least one output device 46, in some examples, may be configured to provide output to a user using audio or video media. For example, at least one output device 246 may include a display, a sound card, a video graphics adapter card, or any other type of device for converting a signal into an appropriate form understandable to humans or machines. In some examples, computing device 180 outputs a representation of one or more of object 160, predetermined surface region 162, plurality of raised features 164, feature surface 167, coating material layer 136 on object 160, transfer roller 140, cliché 120, and doctoring cup 130.

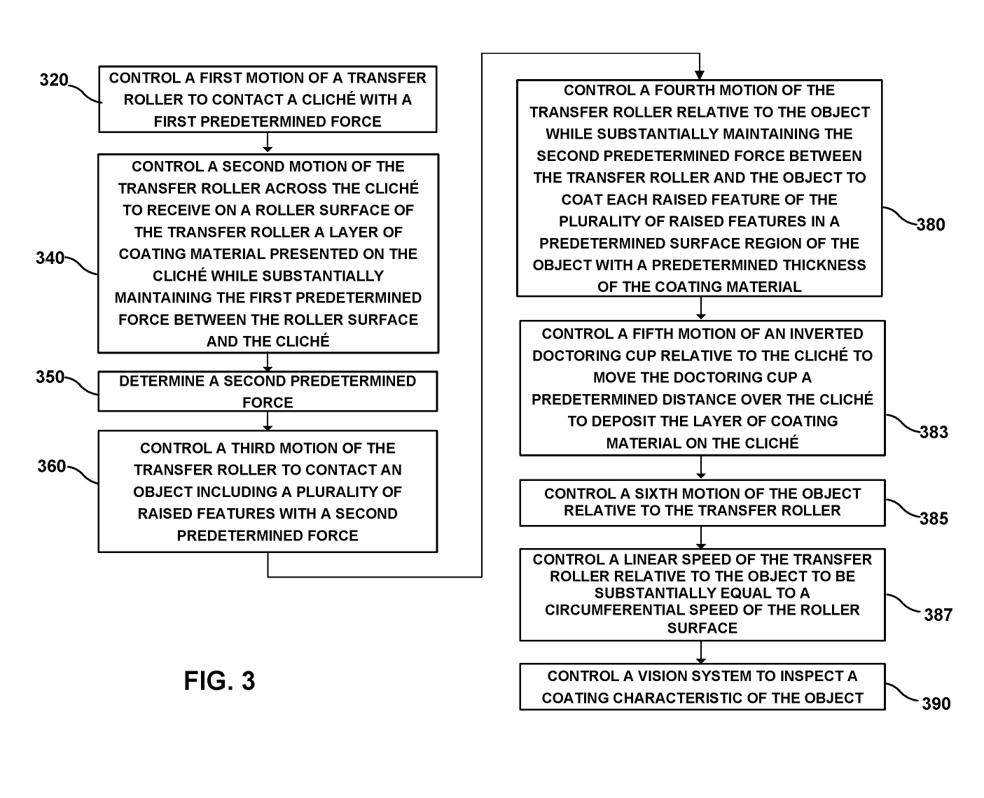

Computing device 180 may include force calculation module 250, for calculating the first predetermined force, the second predetermined force, or both. Computing device 180 may include manipulator control module 252, for controlling one or more of roller manipulator 148, object manipulator 168, and cup manipulator 138. Computing device 180 may include vision system control module 254, for controlling vision system 170. Force calculation module 250, manipulator control module 252, or vision system control module 254 may be implemented in various ways. For example, one or more of force calculation module 250, manipulator control module 252, or vision system control module 254 may be implemented as software, such as an executable application or an operating system, or firmware executed by one or more processors 240. In other examples, one or more of force calculation module 250, manipulator control module 252, or vision system control module 254 may be implemented as part of a hardware unit of computing device 200. Functions performed by force calculation module 250, manipulator control module 252, and vision system control module 254 are explained below with reference to the example flow diagram illustrated in FIG. 3.

Computing device 180 may include additional components that, for clarity, are not shown in FIG. 2. For example, computing device 180 may include a power supply to provide power to the components of computing device 180. Similarly, each component of computing device 180 shown in FIG. 2 may not be necessary in every example of computing device 180.

FIG. 3 is a flow diagram illustrating an example technique for coating a plurality of raised features 164 of object 160 with coating material 132. The technique of FIG. 3 will be described with reference to system 100 of FIGS. 1A-1C and computing device 180 of FIG. 2. While in some examples, system 100 of FIGS. 1A to 1C or computing device 180 of FIG. 2 may be used to perform the technique of FIG. 2, other example systems or computing devices may be used to perform example techniques described with reference to the flow diagram of FIG. 3 below. For example, example techniques may be performed by systems that do not include a computing device, for instance, systems that use mechanical controllers or manipulators, and mechanical mechanisms for guiding one or more of doctoring cup 130, transfer roller 140, or object 160, and using mechanical mechanisms, for instance, springs and weights, for imparting predetermined velocities and forces to one or more components. As another example, example techniques may be performed by systems that include both a computing device and mechanical controllers or manipulators, and mechanical mechanisms for guiding one or more of doctoring cup 130, transfer roller 140, or object 160.

The technique of FIG. 3 includes, controlling, by manipulator control module 252 of computing device 180, roller manipulator 148 to control transfer roller 140 to contact cliché 120 with a first predetermined force (320). In some examples, the first predetermined force may be determined by a user (e.g., a technician) and input to computing device 180 using at least one input device 242. In other examples, computing device 180 may determine the first predetermined force based on parameters provided to computing device 180. For example, force control module 250 may calculate the first predetermined force based at least in part on the material of roller surface 142, a composition of coating material 132, or a configuration of cliché 120 so that cliché 120 provides a substantially uniform (e.g., uniform or nearly uniform) selected first thickness of the coating material 132 on roller surface 142 of transfer roller 140. For example, if the first predetermined force is too high or too low, a non-uniform layer of coating material 132 may be collected by roller surface 142. Hence, the predetermined force may be determined to deposit coating material 132 with a substantially uniform thickness on roller surface 142.

In some examples, roller surface 142 may include stripes or other patterns of coating material such that roller surface 142 exhibits a substantially uniform (e.g., uniform or nearly uniform) thickness of coating material 132 only on portions of roller surface 142. Thus in some examples, roller surface 142 may only carry material 132 on a portion of roller surface 142. In other examples, roller surface 142 may carry material 132 on substantially an entire surface of roller surface 142.

The technique of FIG. 3 also may include controlling, by manipulator control module 252 of computing device 180, roller manipulator 48 to control a second motion of transfer roller 140 across cliché 120, to cause transfer roller 140 to receive on roller surface 142 a layer including coating material 132 presented on cliché 120 (340). For example, manipulator control module may control roller manipulator 148 to maintain the first predetermined force between roller surface 142 and cliché 120 during the second motion (340), so that, where coating material 132 is deposited on roller surface 142, the thickness of coating material 132 is substantially the same (e.g., the same or nearly the same). Retaining a substantially uniform (e.g., uniform or nearly uniform) thickness of coating material 132 on coated portions of roller surface 142 helps promote a uniform thickness of coating material layer 136 on object 160 when transfer roller 140 contacts object 160.

In some examples, the technique of FIG. 3 also includes controlling, by manipulator control module 252 of computing device 180, roller manipulator 148 to control a third motion of transfer roller 140 to contact object 160 with a second predetermined force (360). In some examples, the second predetermined force may be determined by a user (e.g., a technician) and input to computing device 180 using at least one input device 242. In other examples, computing device 180 may determine the second predetermined force based on parameters provided to computing device 180 (350). The parameters may include, for example, at least one of the material of roller surface 142, a composition of coating material 132, a composition of object 160, or the like. For example, force control module 250 may calculate the second predetermined force so that transfer roller 140 transfers a substantially uniform (e.g., uniform or nearly uniform) selected second thickness of coating material 132 on plurality of raised features 164 on object 160, e.g., coating material layer 136.

In some examples, manipulator control module 252 may control roller manipulator 148 to control a fourth motion of transfer roller 140 relative to object 160 while substantially maintaining the second predetermined force between transfer roller 140 and object 160 (380). In some examples, the second predetermined force is calculated to cause transfer roller 140 to coat a respective feature surface 167 of each raised feature of plurality of raised features 164 with a selected thickness of coating material layer 136, as shown in FIG. 1C. For example, if the second predetermined force is too high, coating material 132 may be deposited in surface regions between plurality of raised features 164 of object 160, and coating material may unacceptably occupy regions between each raised feature of plurality of raised features 164. Alternatively, too much coating material 132 may be deposited in coating material layer 136, and coating material 132 may flow down side surfaces of raised features of plurality of raised features 164, which also may be unacceptable. Conversely, if the second predetermined force is too low, an insufficient thickness of coating material layer 136 may be deposited on plurality of raised features 164. Thus, in some examples, computing device 180 may calculate the first predetermined force to cause transfer roller 140 to receive a layer of coating material 132 of a first selected thickness from contact surface 122 of cliché 120, and calculate the second predetermined force cause transfer roller 140 to coat feature surface 167 of each raised feature of plurality of raised features 164 in predetermined surface region 162 of object 160 with a second selected thickness of coating material layer 136. For example, manipulator control module 252 may control roller manipulator 148 to cause transfer roller 140 to coat feature surface 168 of each raised feature of plurality of raised features 164 in predetermined surface region 162 of object 160 with a predetermined thickness of coating material 132, for example, coating material layer 136 (380).

In some examples, the technique of FIG. 3 optionally includes controlling, by manipulator control module 252 of computing device 180, cup manipulator 138 to control a motion of inverted doctoring cup 130 relative to cliché 120 while substantially maintaining (e.g., maintaining or nearly maintaining) a controlled distance between doctoring edge 134 of doctoring cup 130 and cliché 120 or adjacent surface 124. In some examples, manipulator control module 252 controls cup manipulator 138 to move doctoring cup 130 a predetermined distance over cliché 120 to deposit the layer of coating material 132 on cliché 120 (383).

In some examples, the technique of FIG. 3 additionally or alternatively includes optionally controlling, by manipulator control module 252, object manipulator 168 to control a motion of object 160 relative to transfer roller 140 (385). For example, manipulator control module 252 may control object manipulator 168 to change a path of transfer roller 140 over the surface of object 160, or a combined motion of object 160 and transfer roller 140 to access all predetermined portions of object 160, for example, predetermined surface region 162 of the object 160. Manipulator control module 252 may optionally control a linear speed of transfer roller 140 relative to object 160 to be substantially equal to a circumferential speed of roller surface 142, by controlling one or both of roller manipulator 148 and object manipulator 168 (387).

In some examples, the technique of FIG. 3 optionally includes controlling, by vision system control module 254 of computing device 180, vision system 170 to inspect a coating characteristic of object 160 (390). In some examples, vision system control module 254 may control vision system 170 to repeatedly scan at least predetermined surface region 162 of object 160, so that computing device 180 may receive real-time or near real-time feedback on the progress or quality of coating of object 160. In other examples, vision system control module 254 may control vision system 170 to scan at least predetermined surface region 162 of object 160 after coating of predetermined surface region 162 is complete. In some example techniques, vision system control module 254 includes a lighting control module for controlling lighting conditions in the environment of system 100, and vision system 170 may scan object 160 under one or more selected lighting conditions.

In some examples, based on the image data received from vision system 170, computing device 180 may control system 100, for instance, by controlling one or more of roller manipulator 148, object manipulator 168, and cup manipulator 138, to correct deviations from selected coating characteristics, or to stop coating when selected coating characteristics are achieved.

In some examples, the technique of FIG. 3 optionally includes outputting, by at least one output device 246, at least one of a raw or a processed image received by computing device 180 from vision system 170, a representation of the raw or processed image (e.g., a false-color schematic), a representation of the extent of predetermined surface region 162 that has been coated with coating material 132 (e.g., a graph presenting % area coated), a representation of the average thickness of coating material layer 136 on plurality of raised features 164, a representation of location of one or more of transfer roller 140, doctoring cup 130, or object 160, a representation of one or more of the relative linear speed or absolute linear speed of object 160 or transfer roller 140, or a representation of a circumferential speed of roller surface 142. Thus, computing device 180 may provide an operator with information about the status of system 100, or one or more of its components, or a status of techniques performed by system 100 or one or more of its components.

Example systems, techniques, and computer readable storage media for coating a coating material on substantially only (e.g., only or nearly only) a plurality of raised features of an object have been described. For example, a computing device may control a transfer roller to roll across a predetermined surface region of the object to coat each raised feature of the plurality of raised features in the predetermined surface region with a predetermined thickness of the coating material. The coating material may include a binder for temporarily or permanently bonding metal or alloy surfaces. In this way, by controlling the transfer roller to move relative to the object while substantially maintaining a predetermined force, the systems and techniques described herein may deposit a substantially uniform (e.g., uniform or nearly uniform) coating and substantially only (e.g., only or nearly only) surfaces of the plurality of raised features, even in instances in which a surface of the object in the predetermined surface region is curved.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

Although various examples have been described with reference to different figures, features of the examples and the examples themselves may be combined in various combinations. For example, the roller manipulator, cup manipulator, or object manipulator may include springs or weighted mechanisms or other mechanical components capable of applying a predetermined fixed or variable force. In some examples, the roller, doctoring cup, or the object may be move along a fixed cam track, slot or groove defining a predetermined path. Other combinations of the techniques described herein are also contemplated by this disclosure and will be apparent to those of ordinary skill in the art.

Various examples have been described. These and other examples are within the scope of the following claims.

1. A system comprising:
a transfer roller comprising a roller surface;
a cliché configured to present a layer of coating material to the roller surface;
a roller manipulator configured to move the transfer roller relative to the cliché and an object comprising a plurality of raised features; and
a computing device comprising a manipulator control module configured to control the roller manipulator to:
move the transfer roller to contact the cliché with a first predetermined force;
move the transfer roller relative to the cliché to receive coating material from the layer of coating material while substantially maintaining the first predetermined force between the transfer roller and the cliché;
move the transfer roller to contact the object with a second predetermined force; and
move the transfer roller relative to the object while substantially maintaining the second predetermined force between the transfer roller and the object to coat each raised feature of the plurality of raised features in a predetermined surface region of the object with a predetermined thickness of the coating material.

2. The system of claim 1, wherein the predetermined surface region comprises a curved surface of the object.

3. The system of claim 1, wherein the force calculation module is configured to determine the second predetermined force such that the roller surface coats substantially only a feature surface of each raised feature of the raised features in the predetermined surface region.

4. The system of claim 1, further comprising an inverted doctoring cup configured to contain a volume of the coating material and a cup manipulator for moving the doctoring cup relative to the cliché while maintaining a substantially sealed sliding relationship between a doctoring edge of the inverted doctoring cup and the cliché or a surface adjacent to the cliché, wherein the manipulator control module is further configured to control the cup manipulator to move the doctoring cup a predetermined distance over the cliché to deposit the layer of coating material on the cliché.

5. The system of claim 1, further comprising an object manipulator configured to move the object relative to the transfer roller, wherein the manipulator control module is further configured to control the object manipulator.

6. The system of claim 5, wherein the manipulator control module is further configured to control the object manipulator to move the object to cause the roller surface to contact the predetermined surface region of the object.

7. The system of claim 1, wherein the manipulator control module is further configured to control a linear speed of the transfer roller relative to the object to be substantially equal to a circumferential speed of the roller surface.

8. The system of claim 1, wherein the coating material comprises a binder.

9. The system of claim 1, further comprising a vision system configured to inspect a coating characteristic of the object, wherein the computing device further comprises a vision system control module configured to control the vision system.

10. A method comprising:
controlling a first motion of a transfer roller to contact a cliché with a first predetermined force;
controlling a second motion of the transfer roller across the cliché to receive on a roller surface of the transfer roller a layer of coating material presented on the cliché while maintaining the first predetermined force between the roller surface and the cliché;
controlling a third motion of the transfer roller to contact an object comprising a plurality of raised features with a second predetermined force; and
controlling a fourth motion of the transfer roller relative to the object while substantially maintaining the second predetermined force between the transfer roller and the object to coat each raised feature of the plurality of raised features in a predetermined surface region of the object with a predetermined thickness of the coating material.

11. The method of claim 10, wherein the predetermined surface comprises a flat or curved surface of the object.

12. The method of claim 10, wherein a computing device controls the first, second, third, and fourth motion of the transfer roller, further comprising determining, by the computing device, the second predetermined force such that the roller surface coats substantially only a feature surface of each raised feature of the raised features in the predetermined surface region.

13. The method of claim 10, further comprising, by the computing device:
controlling a fifth motion of an inverted doctoring cup relative to the cliché while maintaining a substantially sealed sliding relationship between a doctoring edge of the inverted doctoring cup and the cliché or a surface adjacent to the cliché, wherein the doctoring cup contains a volume of coating material, to move the doctoring cup a predetermined distance over the cliché to deposit the layer of coating material on the cliché.

14. The method of claim 10, further comprising controlling a sixth motion of the object relative to the transfer roller.

15. The method of claim 14, wherein the sixth motion comprises contact between the roller surface and the predetermined surface of the object.

16. The method of claim 10, further comprising controlling a linear speed of the transfer roller relative to the object to be substantially equal to a circumferential speed of the roller surface.

17. The method of claim 10, wherein the coating material comprises a binder.

18. The method of claim 10, further comprising controlling a vision system to inspect a coating characteristic of the object.

19. A computer readable storage medium comprising instructions that, when executed, cause at least one processor to:
control a first motion of a transfer roller to contact a cliché with a first predetermined force;
control a second motion of the transfer roller across the cliché to receive on a roller surface of the transfer roller a layer of coating material presented on the cliché while maintaining the first predetermined force between the roller surface and the cliché;
control a third motion of the transfer roller to contact an object comprising a plurality of raised features with a second predetermined force; and
control a fourth motion of the transfer roller relative to the object while substantially maintaining the second predetermined force between the transfer roller and the object to coat each raised feature of the plurality of raised features in a predetermined surface region of the object with a predetermined thickness of the coating material.

20. The computer readable storage medium of claim 19, further comprising instructions that, when executed, cause the at least one processor to:
control a fifth motion of an inverted doctoring cup relative to the cliché while maintaining a substantially sealed sliding relationship between a doctoring edge of the inverted doctoring cup and the cliché or a surface adjacent to the cliché, wherein the doctoring cup contains a volume of coating material, to move the doctoring cup a predetermined distance over the cliché to deposit the layer of coating material on the cliché.
